(19) United States
(12) Patent Application Publication
(10) Pub. No.: US 2009/0212552 A1
(43) Pub. Date: Aug. 27, 2009

(54) COMMUNICATION APPARATUS AND METHOD OF DISTRIBUTION OF SAME

(76) Inventors: William A. McDonough, Charlottesville, VA (US); Michael Braungart, Buchholz (DE); Bernard J. David, Greenville, DE (US); Susan R. Lyons, New York, NY (US); Peter Walts, Ambler, PA (US)

Correspondence Address: COOLEY GODWARD KRONISH LLP;ATTN: PATENT GROUP, Suite 1100, 777 - 6th Street, NW, WASHINGTON, DC, 20001, US

(21) Appl. No.: 12/436,384

(22) Filed: May 6, 2009

Related U.S. Application Data
(62) Division of application No. 11/270,824, filed on Nov. 10, 2005, now abandoned.
(60) Provisional application No. 60/636,697, filed on Dec. 17, 2004.

(51) Int. Cl. B42D 15/04; G09F 1/04

(52) U.S. Cl. 283/67; 40/124.09

(57) ABSTRACT

A method of processing a communication apparatus includes putting the communication apparatus into a distribution channel for distribution via one or more intermediaries to a user of the communication apparatus, the user of which can forward the communication apparatus to a desired recipient. The communication apparatus includes a substrate and a communication element coupled to the substrate and is constructed of one or more materials that are a bio-technical nutrient. The communication apparatus is received from a recipient directly or via one or more intermediaries. The communication apparatus is processed to prepare a second communication apparatus for distribution to another user.

### CROSS-REFERENCE TO RELATED APPLICATION

This application is a divisional of U.S. patent application Ser. No. 11/270,824, entitled “Communication Apparatus and Method of Distribution of Same,” filed on Nov. 10, 2005, which claims priority under 35 U.S.C. 119(e) to U.S. Provisional Application Ser. No. 60/636,697 entitled “Communication Apparatus and Method of Distribution of Same,” filed on Dec. 17, 2004, the disclosures of which are incorporated herein by reference.

### BACKGROUND OF THE INVENTION

The present invention relates to a method and apparatus for communicating information, and more particularly to an apparatus configured to communicate information and a method of distribution and redistribution of the apparatus.

In an era of increased electronic communication, the use of traditional physical communication mediums, such as greeting cards, post cards, letters and the like is still widespread. With these physical mediums of communication, the lifecycle of the medium is typically of a short duration. Recipients of such mediums of communication usually discard the communication medium shortly after its receipt. The typical method of discarding involves simply placing the communication medium in the trash where it will eventually end up at a landfill. There are many environmental concerns related to the increase of material sent to landfills, as well as the concern over possible toxic chemicals from the discarded communication medium exposing the environment around it.

There are other possible paths for discarding with physical communication mediums that involve recycling the physical medium. Unfortunately, because of undesirable chemical constituents typically present in these mediums, recycling usually means downcycling. In other words, recycling of a medium of communication, such as a greeting card, typically means that the greeting card will be processed for use in some other product of lesser value. Thus, there is a loss of value of the material through the recycling process. Accordingly, there is a need for a physical communication medium that is constructed of material(s) that is safe for the environment, and that allows the medium to be recycled into a product of the same value as the original product and/or is fully biodegradable.

### SUMMARY OF THE INVENTION

A method of processing a communication apparatus includes putting the communication apparatus into a distribution channel for distribution via one or more intermediaries to a user of the communication apparatus, the user of which can forward the communication apparatus to a desired recipient. The communication apparatus includes a substrate and a communication element coupled to the substrate and is constructed of one or more materials that are a bio-technical nutrient. The communication apparatus is received from a recipient directly or via one or more intermediaries. The communication apparatus is processed to prepare a second communication apparatus for distribution to another user.

### BRIEF DESCRIPTION OF THE DRAWINGS

FIG. 1 is a flow diagram illustrating a method according to an embodiment of the invention.

FIG. 2 is a flow diagram illustrating some potential participants in the method of FIG. 1.

FIG. 3 is an illustration of a communication apparatus according to an embodiment of the invention.

FIG. 4A is a front view of a communication apparatus according to another embodiment of the invention in an unfolded state.

FIGS. 4B and 4C are front and rear views, respectively, of the communication apparatus shown in FIG. 4A in a folded state.

FIGS. 5A and 5B are front and rear views, respectively, of a communication apparatus according to another embodiment of the invention in an unfolded state.

FIGS. 6A and 6B are front and rear views, respectively, of the communication apparatus shown in FIGS. 5A and 5B in a folded state illustrating a first and second orientation, respectively.

FIGS. 7A and 7B are front and rear views, respectively, of a communication apparatus according to another embodiment of the invention.

FIG. 8A is a front view of a communication apparatus according to another embodiment of the invention in a folded configuration.

FIG. 8B is a front view of the communication apparatus shown in FIG. 8A in an unfolded state.

FIG. 8C is a front view of the communication apparatus shown in FIGS. 8A and 8B in a reconfigured folded configuration.

FIG. 9 is a front perspective view of a communication apparatus according to another embodiment of the invention.

### DETAILED DESCRIPTION

The present invention provides solutions to the problems associated with the post consumer disposal of physical communication mediums. An apparatus according to the invention is constructed of one or more materials that provide alternative and better paths for post consumer use and disposal of physical communication mediums. These paths provide the recipient of a physical communication medium the option of (1) causing the communication medium to be recycled for reuse as another communication medium, or (2) causing the communication medium to be placed in a location where it can fully biodegrade. Materials can be used that contain low toxicity chemicals, thus eliminating any harmful effects to the environment. Thus, a recipient or other user can dispose of the communication medium in an ecologically benign manner, such as by simply placing the communication medium in the ground.

A physical communication medium or “communication apparatus” as that term is used herein can be configured in a variety of different forms such as a greeting card, an envelope, a note, a postcard, an invitation, a book, a magazine, a catalog, a newspaper, a calendar and the like, or a combination of such forms such as an envelope and greeting card combination. A communication apparatus can include a substrate with one or more communication elements coupled thereto. The communication element can be pictorial, graphical, textual or any other type of communication that is interpretable or viewable by a human recipient. The substrate can be constructed with one or more materials that are either a technical nutrient material, a biological nutrient material or a bio-technical nutrient material as described in more detail below.

A “technical nutrient” material as used herein is a material that is a material of human artifice designed to circulate within an industrial cycle, more than one time and potentially endlessly. It is thus a material appropriate for use in an industrial closed-loop system, that is, a system where an item is manufactured, used, recovered and re-manufactured, continually. A technical nutrient material is therefore recyclable. A recyclable item is typically referred to as an item that is capable of being processed such that one or more materials used to make the item can be reused in some other lower valued form. The item is effectively what is sometimes referred to as “downcycled.” Recyclable as used herein refers to the ability to process an item after its initial use by a consumer/end user and use the item as raw material or feedstock for manufacture of a similar item or another product that makes a similarly high valued use of the material (rather than a lower-valued use). As an example, a technical nutrient material can be a polymer, such as polyester. At the end of its useful life, the polyester can be returned to an industrial process for reuse intact and/or for repolymerization. Preferably, the polyester is processed only with chemicals that are optimized for human and ecological health. Some specific product examples of technical nutrient materials include Victor Innovatex—Eco Intelligent Polyester™ (a synthetic textile), Shaw Eco Solution Q™ (a nylon 6 yarn) and Ecoworx™ (a polyolefin-based thermoplastic, PVC-free backing). Some metals, e.g. iron, are also suitable.

A “biological nutrient” as that term is used herein is a material usable by living organisms or cells to carry on life processes such as growth, cell division, synthesis of carbohydrates, and other complex functions. Biological nutrient materials are typically carbon-based compounds and can biodegrade naturally. Biological nutrients are typically comprised of materials that are rapidly renewable, naturally biodegradable, and all constituents of the material are deemed to be ecologically safe. A naturally biodegradable material is one that poses no immediate or eventual hazard to living systems, and can be used for human purposes and safely returned to the environment to feed the ecological processes. A biological nutrient material disintegrates (breaks down into minute particles and/or into its constituent molecular or atomic components) in common environmental conditions (i.e. in the presence of air and/or water within the temperature range of, for example liquid water) over a time frame that is environmentally appropriate (e.g. over a period of days or weeks, but less than years). Examples of biological nutrient materials include essentially any plant material such as cellulose fibers (e.g. cotton, flax, ramie), plant-based starches, or animal material (animal dermis, gut, hair or wool) and some metals (e.g. iron). A specific product example of a biological nutrient material is Climatex® Lifecycle™ fabric (an organically grown ramie combined with wool). The biological nutrient material is preferably processed only with chemicals that are optimized for human and ecological health.

Materials that would not normally be considered to be naturally biodegradable include most mineral-based materials (e.g. glass), and corrosion-resistant metals (e.g. stainless steels, aluminum). Other examples of, and explanation of the concepts of, technical and biological nutrients are set forth in W. McDonough and M. Braungart, Cradle to Cradle (North Point Press, 2002), the disclosure of which is hereby incorporated by reference in its entirety.

A “bio-technical” or hybrid nutrient material includes properties of both a technical nutrient material and a biological nutrient material. Thus, a bio-technical nutrient material is a material capable of either being recycled for reuse at a high value in an industrial process cycle or being naturally biodegraded. Examples of bio-technical nutrient materials include Cargill Dow's Natureworks™ (a resin made from renewable resources such as corn) and Ingeo™ (a synthetic fiber derived from renewable resources).

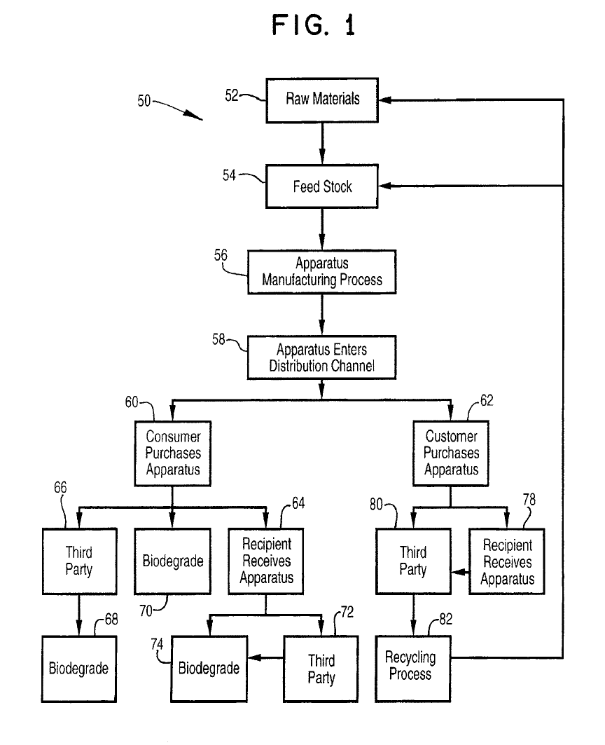

Turning now to the figures, FIG. 1 is a flow diagram illustrating a method according to one embodiment of the invention. A method of distribution 50 begins with one or more raw materials at step 52. The raw material(s) may include one or more materials such as a carbohydrate, a hydrocarbon and a metal, which are used to make a technical nutrient material, a biological nutrient material or a bio-technical nutrient material as described above. The raw material is processed to form feedstock including one or more of a technical nutrient, a biological nutrient or a bio-technical nutrient material at step 54. The feedstock is processed by a manufacturer into a communication apparatus at step 56, including a substrate with one or more communication elements coupled thereto. The communication apparatus is then distributed or placed in a distribution channel at step 58. Either a consumer or a customer purchases the communication apparatus at step 60 and 62, respectively. Consumer as used herein refers to someone who purchases a communication apparatus constructed with one or more biological nutrient materials. A customer as used herein refers to someone who purchases a communication apparatus constructed of a technical nutrient material.

The consumer may transfer the communication apparatus to a recipient at step 64, or alternatively the consumer can retain the communication apparatus for his/her own use. When the consumer is finished with (ready to discard) the communication apparatus, the consumer can transfer the communication apparatus to a third party at step 66 for subsequent placement in a location to naturally biodegrade at step 68. Alternatively, the consumer can directly place the communication apparatus in a location to naturally biodegrade at step 70.

If the communication apparatus was transferred to a recipient at step 64, the recipient can either transfer the communication apparatus to a third party at step 72 for subsequent placement in a location to naturally biodegrade at step 74, or directly place the communication apparatus in a location to naturally biodegrade at step 74.

The customer can transfer the communication apparatus to a recipient at step 78. Alternatively, the customer can retain the communication apparatus for his/her own use. When the customer is finished with (ready to discard) the communication apparatus, the customer can transfer the communication apparatus to a third party at step 80 for subsequent recycling at step 82. After the communication apparatus has been recycled, the resultant processed material(s) can be fed back into the closed-loop manufacturing process as either raw material(s) at step 52 or as feedstock at step 54.

If the communication apparatus was transferred to a recipient at step 78, the recipient can transfer the communication apparatus to a third party at step 80 for subsequent recycling at step 82. After the communication apparatus has been recycled, the resultant processed material(s) can be fed back into the closed-loop manufacturing process as either raw material(s) at step 52 or as feedstock at step 54.

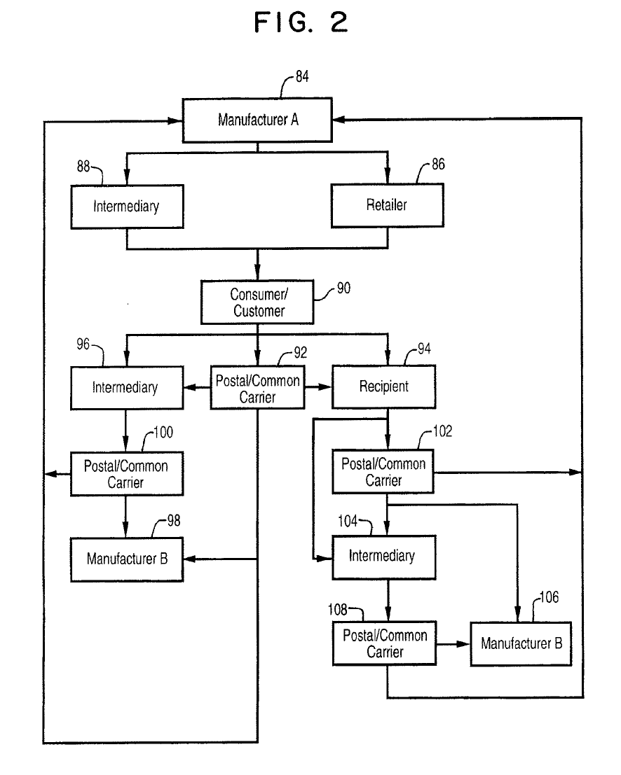

If the communication apparatus is constructed with one or more bio-technical nutrient materials, either a consumer or customer purchases the communication apparatus. Since a communication apparatus constructed of a bio-technical nutrient material is capable of being naturally biodegraded or recycled, either path on FIG. 2 can be taken (i.e., either the path starting at step 60 or the path starting at step 62).

In some embodiments, the recipient or customer/consumer may be instructed to reconfigure the communication apparatus such that a return address will be visible for sending the communication apparatus to a third party. The third party may be a processor, a manufacturer, a distributor or other intermediary. A processor may include a company or entity that can process or recycle the apparatus to prepare it for reuse as a raw material or feedstock to make a product. Recycling the apparatus may include separating the communication element(s) from the substrate. Recycling may also include rolling or ironing the communication apparatus, chemically or thermally treating the communication apparatus and shredding or otherwise re-shaping the communication apparatus.

The manufacturer may be the original manufacturer of the communication apparatus or a different manufacturer. The manufacturer may either perform the recycling process on the communication apparatus, or may send the communication apparatus to a processor to be recycled or processed. A distributor may be a party in the stream of distribution that can send the communication apparatus to a manufacturer or processor for subsequent recycling, or to a location to be subsequently biodegraded. For example, a distributor may be a retail store having a drop box location for which a customer/consumer or recipient can drop-off the communication apparatus when they are finished with it. A drop box can be used for communication apparatuses that will be either subsequently biodegraded or recycled.

After the communication apparatus has been recycled, by a manufacturer, a processor, or other third party, the processed substrate (now a processed material) can then be reintroduced into the stream of distribution as raw material or feedstock.

The feedstock may be provided in a variety of different forms. For example, in some embodiments the feedstock is in the form of rolled material stock. In other embodiments, the feedstock is in the form of material sheets. In some embodiments, a communication apparatus may be manufactured, used and recycled into the same dimensional substrate as the initial substrate, allowing the recycled substrate to be placed back in the product lifecycle as feedstock (rather than raw material) for a product having the same dimensions as the original communication apparatus. In other embodiments, the communication apparatus may be manufactured, used and recycled into a similar substrate as its initial use, but with different dimensions. In other embodiments, the communication apparatus may be recycled and made into various other forms of feedstock and/or raw materials.

FIG. 2 is another flow diagram illustrating various potential participants within the distribution chain/product lifecycle of a communication apparatus of the invention. A manufacturer processes feedstock into a communication apparatus of the invention at step 84 and then may transfer the communication apparatus to a retailer at step 86, either directly, or via an intermediary, such as a retail or wholesale distributor at step 88. A consumer or customer can purchase the communication apparatus from a retailer or intermediary at step 90. Depending on the material used to construct the communication apparatus, the various parties may have different options as to where to transfer the communication apparatus. The consumer/customer can cause the communication apparatus to be transferred to a recipient by either sending the communication apparatus to the recipient via a postal or common carrier at step 92 or giving it directly to a recipient at step 94 (i.e., hand delivery). Alternatively, the consumer/customer may transfer the communication apparatus, either directly or via a postal or common carrier at step 92, to an intermediary at step 96. Or the consumer/customer may transfer the communication apparatus to the original manufacturer of the communication apparatus at step 84, or a different manufacturer at step 98, for subsequent biodegrading or recycling via postal or common carrier at step 92. The intermediary may transfer the communication apparatus to the original manufacturer at step 84 or a different manufacturer at step 98 via postal/common carrier at step 100.

Likewise, the recipient may transfer the communication apparatus to an intermediary either directly at step 104, or via a postal/common carrier at step 102, for subsequent biodegrading or recycling. Alternatively, the recipient may transfer the communication apparatus to the original manufacturer A at step 84 or a different manufacturer B at step 106 via postal/common carrier at step 102 for subsequent biodegrading or recycling. The intermediary may transfer the communication apparatus to the original manufacturer A at step 84 or to a different manufacturer B at step 106 via postal/common carrier at step 108.

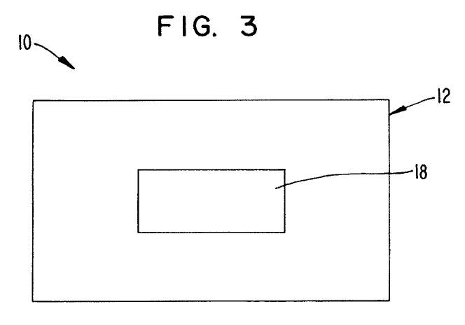

FIG. 3 is an illustration of one implementation of a communication apparatus of the invention. A communication apparatus 10 includes a substrate 12 having at least one communication element 18 coupled thereto. In this embodiment, communication apparatus 10 is in the form of a single planar sheet, such as with a post card or sheet of stationery. In other embodiments, a communication apparatus can be configured in a variety of different forms, such as a greeting card, an envelope, a note, a postcard, an invitation, a catalog, a magazine, a newspaper, a calendar and the like. Multiple communication apparatuses can be used in conjunction with one another such as an envelope and greeting card/letter combination. The substrate 12 may be constructed of one or more biological, technical or bio-technical nutrient materials as described above. In some embodiments, substrate 12 is naturally biodegradable. In other embodiments, substrate 12 is fully recyclable. In other embodiments, substrate 12 is both naturally biodegradable and recyclable. The recyclable embodiments of substrate 12 can continually be used and reused to manufacture identical or similar products. Thus, a product constructed of materials that are recyclable as described above have the potential for a virtually never-ending product lifecycle.

The communication element 18 may include any type of graphical, textual, or pictorial format, including charts, diagrams, and cartographic illustrations viewable and interpretable by a recipient, customer/consumer or other human user. Communication element 18 may be printed directly on substrate 12 with known printing techniques or may be engraved, embossed, attached (such as with an adhesive), formed integrally, or coupled to substrate 12 with any other suitable and known coupling technique. Communication element 18 can include a low toxicity ink, a material suitable for full biodegradability or other suitable compositions. Communication element 18 may also be formed with the same material as used to construct the substrate 12 to allow for simplification of the processing necessary to recycle communication apparatus 10 for subsequent reuse.

Communication element 18, or additional communication elements, may include a variety of different types of communications such as, informational content, personalized content or messages, addresses, return addresses, advertising content and the like. In one embodiment, communication element 18 includes personalized content such as a greeting or other message intended for the recipient (e.g., the text “Happy Birthday” and/or an associated graphic or icon). In another embodiment, communication element 18 includes informational content, such as content found in a book or magazine. In still other embodiments, communication element 18 includes advertising, such as informational content typically found in magazines and newspapers. Communication element 18 may alternatively be, or an additional communication element may be, a postal address for sending communication apparatus 10 to a third party when the recipient or consumer/customer is finished with it. Thus, communication apparatus 10 may be configured to be mailed without the need of a separate envelope to enclose it. One or more additional communication elements may be hand written or attached by the sender of the communication apparatus 10, such as the address or name of the recipient, personalized content, or other desired information.

As described above, the recipient or customer/consumer of communication apparatus 10 will be able to choose alternative paths for disposing of or discarding communication apparatus 10. Instructions may be included in the form of a communication element coupled to substrate 12 to instruct the recipient or customer/consumer on the possible options depending on the particular material used to construct communication apparatus 10. In some embodiments, instructions may be in the form of a website address for receiving further information on how to dispose of communication apparatus 10. Instructions may also be publicly known through advertising and the like.

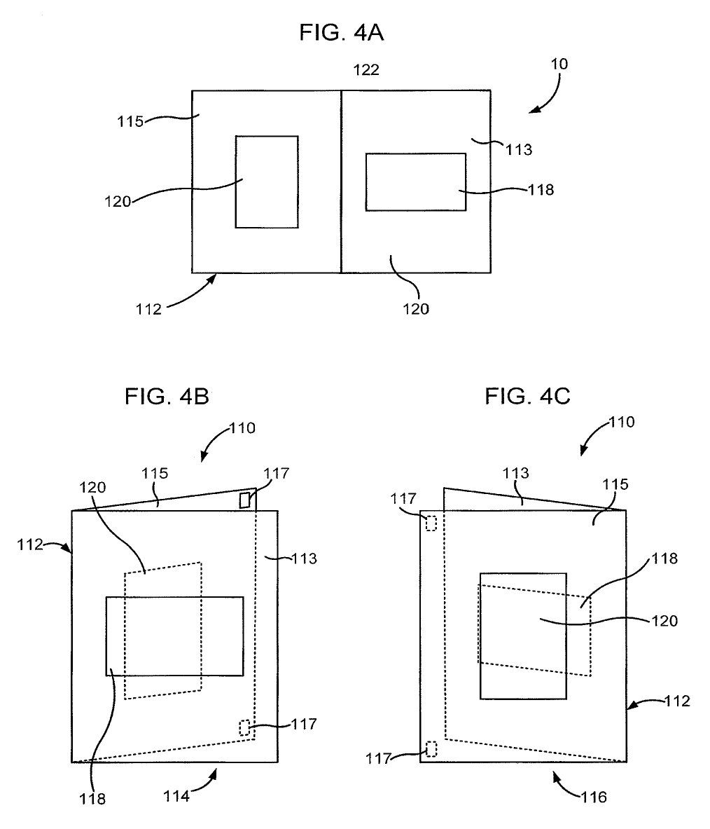

FIGS. 4A-4C illustrate another embodiment of a communication apparatus of the invention. In this embodiment, a communication apparatus 110 includes a substrate 112 having panels 113 and 115 that are foldable along a fold line 122. This embodiment is generally in the form of a greeting card. At least one securing element or fastener 117 may also be coupled to substrate 112. Communication apparatus 110 is reconfigurable between a first orientation 114 as shown in FIG. 4B and a second orientation 116 as shown in FIG. 4C. Communication apparatus 110 includes at least one communication element 118 on panel 113 and at least one communication element 120 on panel 115. For purposes of illustration, only communication elements 118 and 120 are discussed, but it is to be understood that additional communication elements may be included on the front or back of panels 113 and 115 as desired. In the first orientation 114, communication element 118 is configured to communicate a first form of information to a recipient of the substrate 112, such as a greeting or message. In the second orientation 116, second communication element 120 is configured to communicate a second different form of information to the recipient, such as an address for sending communication apparatus 110 to a third party. In the first orientation 114, a front side of panel 113 is facing the recipient, and in the second orientation 116, a back side of panel 113 is facing the recipient. For purposes of illustration, the embodiment of communication apparatus 110 includes only one fold line 122, but it should be understood that communication apparatus 110 may include a different number of fold lines 122, a different number of panels 113, 115, and assume a variety of different shapes and sizes.

Securing element 117 is configured to secure or hold communication apparatus 110 in a closed position for sending communication apparatus 110 to the third party when the recipient is ready to discard it. In some embodiments, securing element 117 may include adhesives, hook and loop fasteners, a mechanical attachment or any other known securing method. In some embodiments, securing element 117 is formed integrally with substrate 112. Securing element 117 is preferably constructed with the same material as substrate 112 to further simplify the process to recycle the communication apparatus 110.

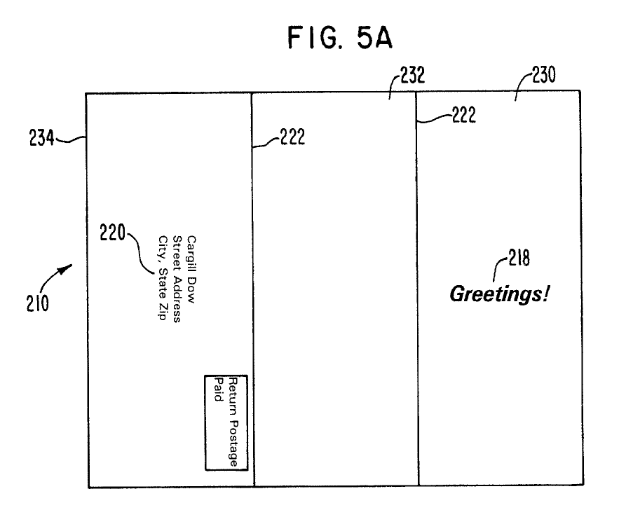

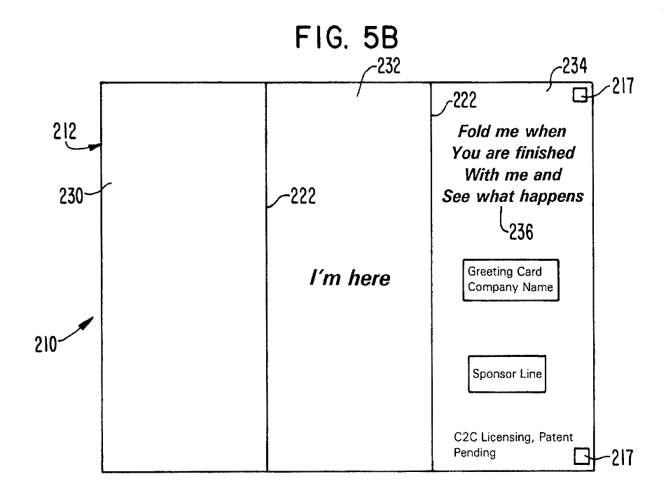

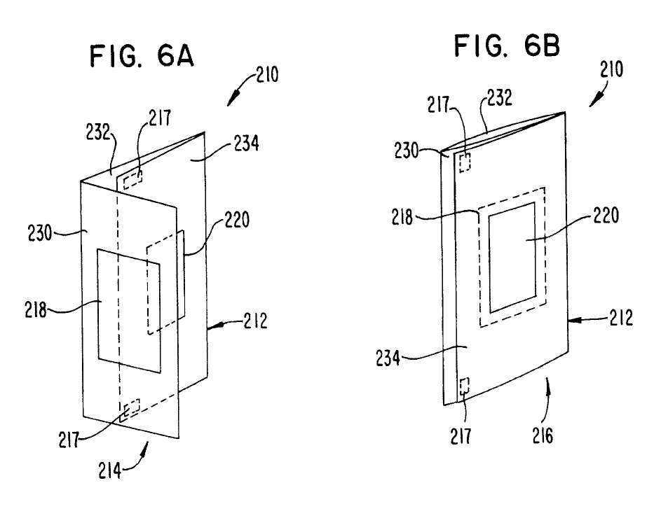

FIG. 5A illustrates a front side and a back side, respectively, of a communication apparatus 210 according to an embodiment of the invention in an unfolded state. Communication apparatus 210 includes a substrate 212 and at least one securing element 217 coupled to substrate 212. Substrate 212 is reconfigurable between a first orientation 214 (see FIG. 6A) and a second orientation 216 (see FIG. 6B). At least one communication element 218 is coupled to substrate 212 that is configured to communicate a first form of information to a recipient of communication apparatus 210 when communication apparatus 210 is in the first orientation 214. At least one second communication element 220 is coupled to substrate 212 that is configured to communicate a second different form of information to the recipient when communication apparatus 210 is in the second orientation 216. In this embodiment, substrate 212 includes three panels 230, 232, and 234, and two fold lines 222. Communication apparatus 210 may be tri-folded into the first orientation 214, such that panel 230 is positioned on top of panel 234 as shown in FIG. 6A. In this orientation, the first communication element 218 is positioned on a front side of panel 230 and the second communication element 220 is positioned on a back side of panel 234, which is now positioned beneath panel 230. After the recipient receives the information conveyed with communication element 218 (and any other communication elements on substrate 212), the recipient can reconfigure communication apparatus 210 such that now panel 234 is positioned on top of panel 232 and the second communication element 220 is viewable as shown in FIG. 6B. The second communication element 220 can be, for example, an address for sending the communication apparatus 210 to a third party via a postal or common carrier. In the second orientation 216, securing element 217 can be used to hold substrate 212 in a closed position with panels 230, 232 and 234 folded on top of each other.

Although only communication elements 218 and 220 have been described, it should be understood that additional communication elements may be positioned on the front or back of any of the panels 230, 232 and 234 as desired. For example, a communication element 236 may be included on panel 232 or panel 234 providing additional information to convey to the recipient.

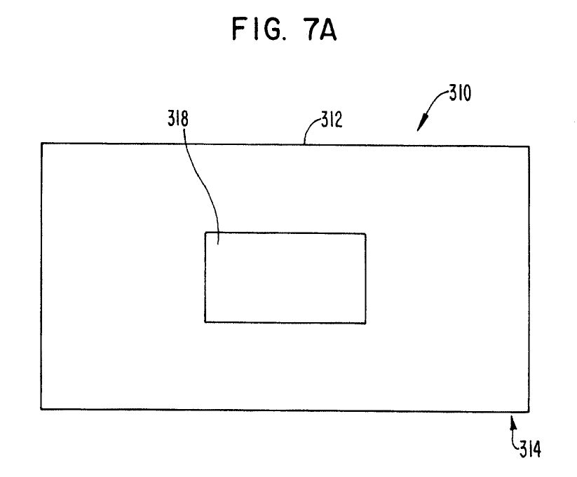

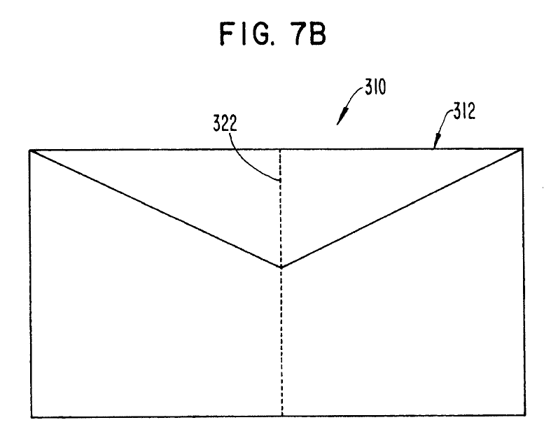

FIGS. 7A and 7B illustrate another embodiment of a communication apparatus 310 of the invention. Communication apparatus 310 includes a substrate 312 in the form of an envelope, with a fold line 322. Communication apparatus 310 is configured to be used in conjunction with another communication apparatus, such as any apparatus 10, 110 or 210 described above. For purposes of illustration, apparatus 310 will be described as used with apparatus 210, but it is to be understood that apparatus 310 may be used with other forms of apparatuses.

Communication apparatus 310 is reconfigurable between a first orientation 314, in which it is configured to contain apparatus 210, and a second orientation 316, in which it is configured to be received within and contained by apparatus 210. At least one communication element 318 may be coupled to substrate 312 and configured to communicate a first form of information to a recipient of communication apparatus 310 in the first orientation 314. In this embodiment, substrate 312 is reconfigurable by folding communication apparatus 310 along fold line 322. Communication apparatus 310 may be constructed with a technical nutrient material, a biological nutrient material or a bio-technical nutrient material as described above, and is preferably constructed with the same material as apparatus 210.

In the first orientation 314, apparatus 310 can be used as an envelope to send apparatus 210 to a recipient. After the recipient has received the information communicated by apparatus 210, the recipient can place apparatus 310 in the folded or second orientation 316, and insert it between panels 230 and 232 of apparatus 210 when apparatus 210 is in its second orientation 216. Thus, communication apparatus 310 can be used as an envelope to send communication apparatus 210 to a recipient and communication apparatus 210 can be used as the envelope to send both communication apparatuses 210 and 310 to a third party for subsequent recycling or biodegrading.

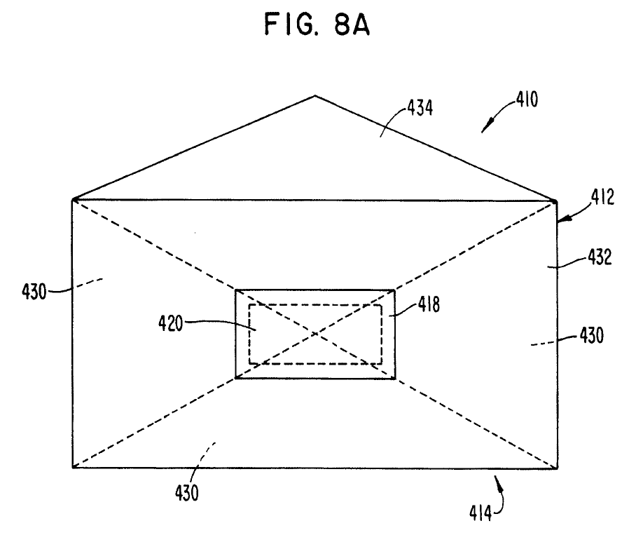

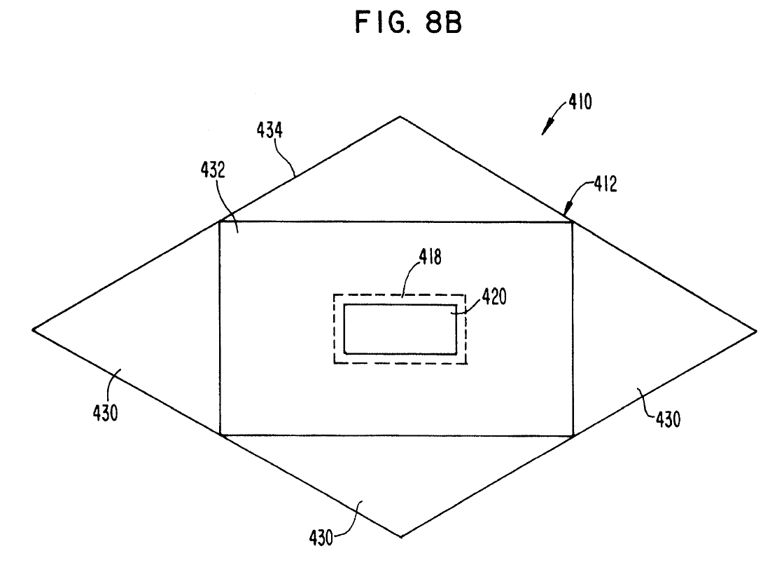

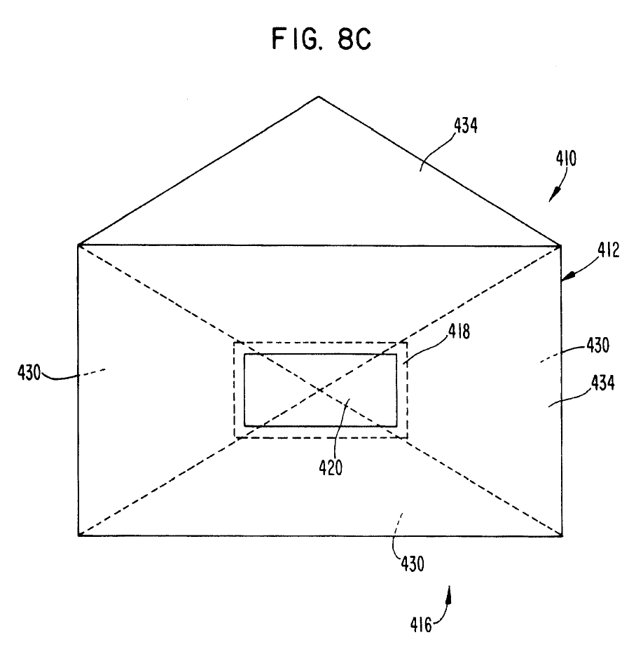

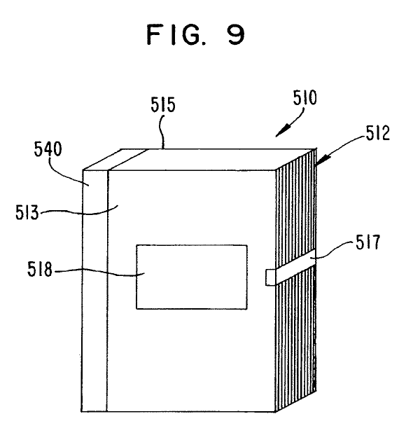

FIGS. 8A, 8B and 8C illustrate another embodiment of a communication apparatus according to the invention. Communication apparatus 410 includes a substrate 412 in the form of an envelope with a plurality of reconfigurable panels 430, a communication panel 432 and a closure panel 434. Apparatus 410 is configured to be used in conjunction with another apparatus, such as apparatus 10, 110, and 210 described above. For purposes of illustration, communication apparatus 410 will be described as used with apparatus 110, but it is to be understood, that communication apparatus 410 may be used with other communication apparatuses.

Communication apparatus 410 is reconfigurable between a first orientation 414 (shown in FIG. 8A) and a second orientation 416 (shown in FIG. 8C). In the first orientation 414, apparatus communication 410 is configured to be sent by a consumer or user to a recipient. In the second orientation 416, communication apparatus 410 is configured to be sent by the recipient to a third party to be processed for subsequent reuse as another communication apparatus. Communication panel 432 includes at least one first communication element 418 on one side and at least one second communication element 420 on an opposite side. In the first orientation 414 as shown in FIG. 8A, the communication element 418 is positioned to communicate a first form of information, such as an address of the intended recipient or the name of the intended recipient. Another apparatus, such as communication apparatus 110 may be placed inside communication apparatus 410 and sent to the intended recipient. When the recipient is ready to discard with communication apparatuses 110 and 410, the recipient can reconfigure communication apparatus 410 such that now the second communication element 420 is positioned to communicate a second form of information, such as a return address to send communication apparatus 410 to a third party for subsequent recycling. To reconfigure apparatus 410, the recipient unfolds the plurality of panels 430 (see FIG. 8B) and inverts them so that they are now positioned on top of the first communication element 418. Unfolding and inverting the reconfigurable panels 430 reveals the second communication element 420 (as shown in FIG. 8C) to enable the recipient to now send apparatus 410 to the specified third party.

FIG. 9 illustrates another embodiment of a communication apparatus of the invention. In this embodiment, a communication apparatus 510 includes a plurality of substrates 512. In this embodiment, the plurality of substrates 512 include a pair of outer panels 513 and 515. This embodiment is generally in the form of a book, but may include a variety of forms having a plurality of substrates 512, such as a calendar, a magazine, a catalog, a newspaper, and the like. At least one securing element or fastener 517 and a binding 540 may also be coupled to one or more of the plurality of substrates 512. Binding 540 may be any typical binding construction used to bind pages together such as adhesives, ring binders, and the like. Communication apparatus 510 includes a single communication element 518 on outer panel 513, but may include any number of communication elements on any one of the plurality of substrates 512. As with the previous embodiments, communication apparatus 510 may be constructed with a technical nutrient material, a biological nutrient material or a bio-technical nutrient material as described above.

### CONCLUSION

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents.

The previous description of the embodiments is provided to enable any person skilled in the art to make or use the invention. While the invention has been particularly shown and described with reference to embodiments thereof, it will be understood by those skilled in art that various changes in form and details may be made therein without departing from the spirit and scope of the invention.

For example, a communication apparatus of the invention may include one or more substrates, the one or more substrates may have one or more panels, one or more fold lines (or no fold lines at all) and include one or more communication elements. Communication elements may be located on any side of any panel of the communication apparatus. The communication apparatus may be reconfigurable between a first orientation in which a first element of information is viewable by a recipient or other user and a second orientation in which a second element of information is viewable by the recipient or other user.

The communication apparatus can be in a variety of different forms such as a single planar sheet, a post card, a sheet of stationery, a greeting card, an invitation, an envelope, a catalog, a calendar, a magazine, a newspaper, a book and the like. The communication apparatus can also be used in conjunction with other communication apparatuses, such as an envelop used in conjunction with a greeting card. When two or more communication apparatuses are used in conjunction with each other, they may be the same material or different from each other. Thus, one or more of the apparatuses may be recyclable, biodegradable or both, depending on the particular material used for each.

What is claimed is:

1. A method of processing a communication apparatus including a substrate and a communication element coupled to the substrate, the communication apparatus being constructed of one or more materials that are a bio-technical nutrient, comprising:
putting the communication apparatus into a distribution channel for distribution via one or more intermediaries to a user of the communication apparatus, which user can forward the communication apparatus to a desired recipient;
receiving the communication apparatus from a recipient directly or via one or more intermediaries; and
processing the communication apparatus to prepare a second communication apparatus for distribution to another user.

2. The method of claim 1, wherein processing the communication apparatus includes separating the communication element from the substrate.

3. A method of processing a communication apparatus including a substrate and a communication element coupled to the substrate, the communication apparatus being constructed of one or more materials that are a bio-technical nutrient, comprising:
receiving the communication apparatus via one of a postal or common carrier; and
causing the communication apparatus to either be forwarded to a third party for subsequent processing or to be placed in a location to biodegrade.

4. A method of processing a communication apparatus including a substrate and a communication element coupled to the substrate, the communication apparatus being constructed of one or more polymer materials, comprising:
putting the communication apparatus into a distribution channel for distribution via one or more intermediaries to a user of the communication apparatus;
receiving the communication apparatus from a user directly or via one or more intermediaries; and
processing the communication apparatus to prepare another product that makes a high valued use of the material.
